(19) United States
(12) Patent Application Publication
(10) Pub. No.: US 2026/0122401 A1
(43) Pub. Date: Apr. 30, 2026

(54) EARPHONE

(71) Applicant: Luxshare Precision Industry Company Limited, SHENZHEN (CN)

(72) Inventors: Heng Zhang, SHENZHEN (CN); Guoyi Zhang, SHENZHEN (CN)

(73) Assignee: Luxshare Precision Industry Company Limited, SHENZHEN (CN)

(21) Appl. No.: 19/364,442

(22) Filed: Oct. 21, 2025

(30) Foreign Application Priority Data
Oct. 29, 2024 (CN) 202411527456.3

(51) Int. Cl. H04R 1/10; H04R 1/34

(52) U.S. Cl. CPC H04R 1/1058; H04R 1/1016; H04R 1/345

(57) ABSTRACT

An earphone includes an ear tip assembly structure and an ear tip. The ear tip assembly structure includes a housing, a sound guide tube, and an elastic support. The sound guide tube includes a main body portion and an outward expansion portion formed by extending the lower end of the main body portion outward. The outward expansion portion is located inside the housing and abuts against the inner wall of the housing. The main body portion extends out of the housing. The elastic support is disposed inside the sound guide tube and includes a snap fastener. The snap fastener extends out of the sound guide tube. The ear tip has a locking groove to engage with the snap fastener. The bottom of the ear tip is disposed between the housing and the sound guide tube. The ear tip abuts against both the housing and the outward expansion portion.

### CLAIM OF PRIORITY AND CROSS-REFERENCE TO RELATED APPLICATION(S)

This application claims the benefit of Chinese Patent Application No. 202411527456.3, filed on Oct. 29, 2024, which is incorporated herein by reference in its entirety.

### BACKGROUND OF THE DISCLOSURE

### 1. Field of the Disclosure

The present disclosure relates to the field of earphone assembly, and particularly to an earphone.

### 2. Description of the Related Art

Currently, earphones on the market usually rely on interference between a silicone ear tip and a plastic shell to complete assembly during ear tip assembly. This assembly process is relatively troublesome, and long-term use may easily cause the ear tip to fall off.

### BRIEF DESCRIPTION OF THE DISCLOSURE

In view of this, the present disclosure is to provide an earphone. The earphone engages the snap-connected ear tip with the housing and the sound guide tube, making assembly simple and the ear tip not easy to dislodge.

An embodiment of the present disclosure provides an earphone. The earphone includes: an ear tip assembly structure, the ear tip assembly structure comprising a housing, a sound guide tube, and an elastic support, the sound guide tube comprising a main body portion and an outward expansion portion, the outward expansion portion extending outward from a lower end of the main body portion, the outward expansion portion being located inside the housing and abutting against an inner wall of the housing, the main body portion extending out of the housing, the elastic support being disposed inside the sound guide tube and comprising a snap fastener, the snap fastener extending out of the sound guide tube; and an ear tip, the ear tip being provided with a locking groove to engage with the snap fastener, a bottom of the ear tip being disposed between the housing and the sound guide tube, the ear tip abutting against both the housing and the outward expansion portion.

In some embodiments, an inner side wall of the main body portion protrudes inward to form a first protrusion portion, the first protrusion portion matching with the elastic support.

In some embodiments, the elastic support further comprises: an elastic arm, the elastic arm being connected to the snap fastener and being bent in a horizontal direction.

In some embodiments, an inner side wall of the main body portion protrudes inward to form a second protrusion portion, the second protrusion portion being located at a bent position of the elastic arm and matching with the elastic arm.

In some embodiments, the elastic support further comprises: an elastic arm, the elastic arm being connected to the snap fastener and being bent in a vertical direction.

In some embodiments, the elastic support further comprises: a base, the base being connected to the elastic arm and abutting against the bottom of the sound guide tube.

In some embodiments, the elastic arm comprises: a bearing portion, the bearing portion extending horizontally from the snap fastener; and a support portion, the support portion extending vertically from the bearing portion and being connected to the base.

In some embodiments, the ear tip is provided with a guide surface, the guide surface inclining outward from top to bottom; a top of the snap fastener is provided with a mating surface, the mating surface inclining outward from top to bottom.

In some embodiments, a bottom of the snap fastener is provided with an arc surface.

In some embodiments, a lower wall of the locking groove is arranged horizontally; an upper wall of the locking groove inclines outward from top to bottom.

In some embodiments, a side wall of the sound guide tube is provided with a snap hole; the snap fastener extends out of the sound guide tube through the snap hole.

### BRIEF DESCRIPTION OF THE DRAWINGS

Through the description of the embodiments of the present disclosure with reference to the accompanying drawings, the above and other purposes, features, and advantages of the present disclosure will become clearer. In the drawings:

FIG. 1 is a schematic structural diagram of an earphone according to an embodiment of the present disclosure;

FIG. 2 is an exploded schematic diagram of an earphone according to an embodiment of the present disclosure;

FIG. 3 is a schematic cross-sectional view of an earphone before assembly according to an embodiment of the present disclosure;

FIG. 4 is a schematic cross-sectional view of an earphone after assembly according to an embodiment of the present disclosure;

FIG. 5 is a schematic structural diagram of a connection portion according to an embodiment of the present disclosure;

FIG. 6 is a schematic structural diagram of the connection portion from another perspective according to an embodiment of the present disclosure;

FIG. 7 is a schematic structural diagram of an earbud portion according to an embodiment of the present disclosure;

FIG. 8 is a schematic structural diagram of the earbud portion from another perspective according to an embodiment of the present disclosure;

FIG. 9 is a schematic structural diagram of an elastic support according to an embodiment of the present disclosure;

FIG. 10 is a schematic structural diagram of a housing according to an embodiment of the present disclosure;

FIG. 11 is a schematic structural diagram of a sound guide tube according to an embodiment of the present disclosure;

FIG. 12 is a schematic structural diagram of the sound guide tube from another perspective according to an embodiment of the present disclosure;

FIG. 13 is a schematic structural diagram of another elastic support provided by an embodiment of the present disclosure;

FIG. 14 is a schematic structural diagram of yet another elastic support according to an embodiment of the present disclosure;

FIG. 15 is a schematic structural diagram of another sound guide tube according to an embodiment of the present disclosure;

FIG. 16 is a schematic structural diagram of the another sound guide tube from another perspective according to an embodiment of the present disclosure;

FIG. 17 is a schematic structural diagram of still another elastic support according to an embodiment of the present disclosure;

FIG. 18 is a schematic structural diagram of yet another sound guide tube according to an embodiment of the present disclosure;

FIG. 19 is a schematic structural diagram of the yet another sound guide tube from another perspective according to an embodiment of the present disclosure.

### DETAILED DESCRIPTION OF EMBODIMENTS OF THE DISCLOSURE

The present application is described below based on embodiments, but the present application is not limited to these embodiments. In the following detailed description of the present application, some specific detailed parts are described in detail. Those skilled in the art may fully understand the present application without the description of these detailed parts. In order to avoid obscuring the essence of the present application, well-known methods, procedures, flows, components, and circuits are not described in detail.

Furthermore, those of ordinary skill in the art should understand that the drawings provided herein are for illustrative purposes, and the drawings are not necessarily drawn to scale.

Unless otherwise clearly specified and defined, terms such as “install”, “connect”, “link”, “fix”, etc., should be understood broadly. For example, it may be a fixed connection, a detachable connection, or an integral connection; it may be a mechanical connection, an electrical connection; it may be a direct connection, or an indirect connection through an intermediate medium, it may be the internal communication between two components or the interaction relationship between two components, unless otherwise clearly defined. For those of ordinary skill in the art, the specific meanings of the above terms in the present application may be understood according to the specific situation.

For ease of description, spatial relative terms such as “inside”, “outside”, “under”, “below”, “lower part”, “above”, “upper part”, etc., are used herein to describe the relationship between one element or feature illustrated in the drawing and another element or feature. It will be understood that the spatial relative terms are intended to encompass different orientations of the device in use or operation in addition to the orientation depicted in the drawings. For example, if the device in the drawing is turned over, an element described as being “below” or “under” another element or feature would then be oriented “above” the other element or feature. Thus, the exemplary term “below” may encompass both above and below orientations. The device may be oriented in other ways (rotated 90 degrees or at other orientations), and the spatial relative descriptors used herein should be interpreted accordingly.

Unless the context clearly requires otherwise, throughout the description and the claims, the words “comprise”, “include”, and the like are to be construed in an inclusive sense as opposed to an exclusive or exhaustive sense; that is to say, in the sense of “including but not limited to”.

In the description of the present application, it is to be understood that the terms “first”, “second”, etc., are used for descriptive purposes only and cannot be understood as indicating or implying relative importance. Furthermore, in the description of the present application, unless otherwise specified, “a plurality of” means two or more.

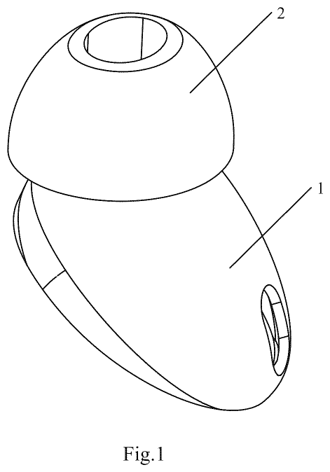

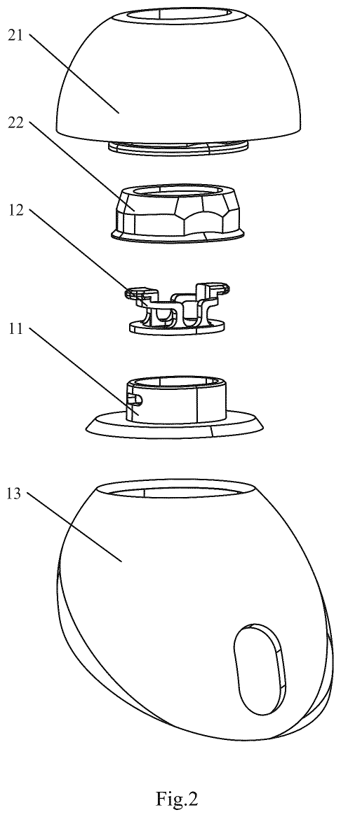

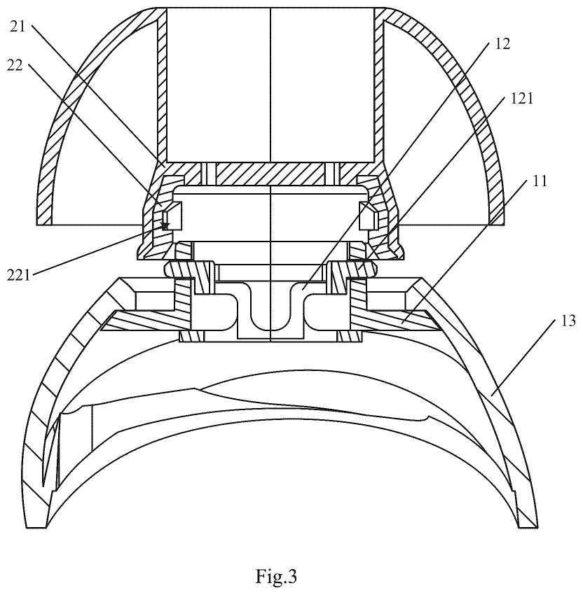

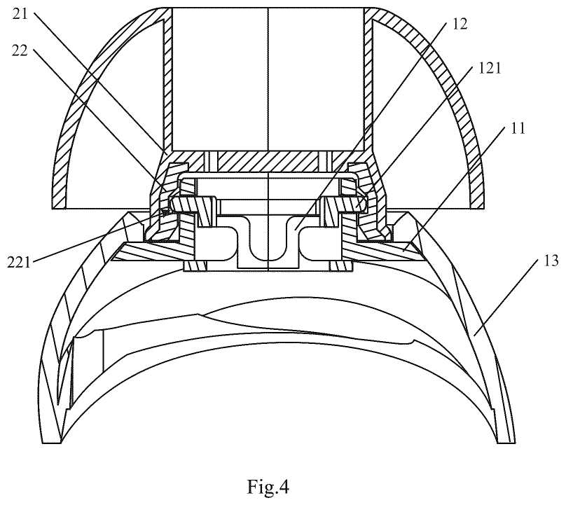

FIG. 1 is a schematic structural diagram of an earphone provided by an embodiment of the present disclosure. As shown in FIG. 1, the earphone includes an ear tip assembly structure 1 and an ear tip 2. The ear tip 2 is assembled on the ear tip assembly structure 1. It should be noted that the ear tip 2 is detachably connected to the ear tip assembly structure 1, thereby enabling the disassembly, assembly, and replacement of the ear tip 2. FIG. 2 is an exploded schematic diagram of an earphone provided by an embodiment of the present disclosure. FIG. 3 is a schematic cross-sectional view of an earphone before assembly provided by an embodiment of the present disclosure. FIG. 4 is a schematic cross-sectional view of an earphone after assembly provided by an embodiment of the present disclosure. With reference to FIG. 2, FIG. 3, and FIG. 4, the ear tip assembly structure 1 provided by the embodiment of the present disclosure includes a sound guide tube 11, an elastic support 12, and a housing 13. The elastic support 12 is disposed inside the sound guide tube 11 and includes a snap fastener 121. The snap fastener 121 extends out of the sound guide tube 11 to engage with the ear tip 2, thereby enabling the detachable connection between the ear tip assembly structure 1 and the ear tip 2.

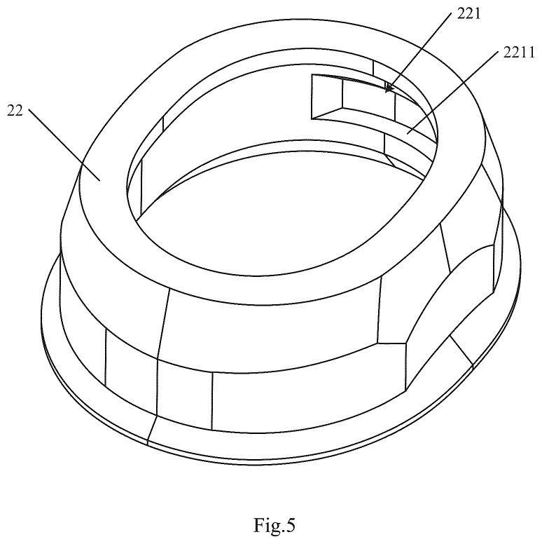

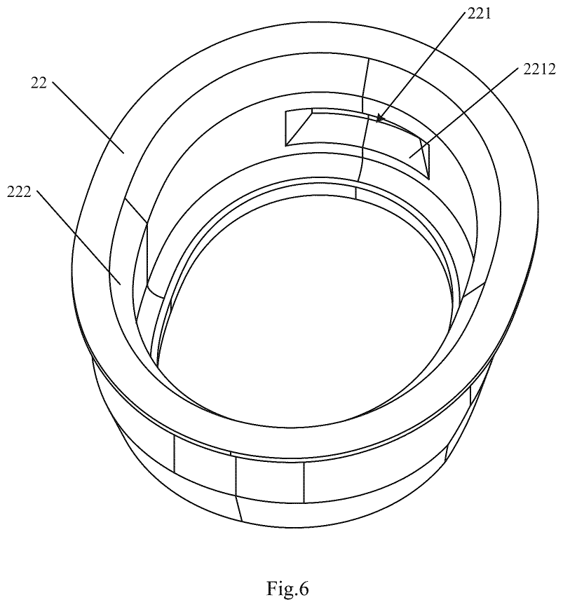

With reference to FIG. 2, FIG. 3, and FIG. 4, the ear tip 2 provided by the embodiment of the present disclosure includes an earbud portion 21 and a connection portion 22. The earbud portion 21 covers the outside of the connection portion 22. FIG. 5 is a schematic structural diagram of a connection portion provided by an embodiment of the present disclosure. FIG. 6 is a schematic structural diagram of the connection portion from another perspective provided by an embodiment of the present disclosure. With reference to FIG. 5 and FIG. 6, the connection portion 22 is configured as a tubular structure. Further, as shown in FIG. 4, the connection portion 22 is sleeved on the sound guide tube 11. It should be noted that the hardness of the earbud portion 21 is less than that of the connection portion 22. Optionally, the earbud portion 21 is made of silicone material, the connection portion 22 is made of plastic material, and the earbud portion 21 and the connection portion 22 are integrally formed. Thus, the ear tip 2 engages with the snap fastener 121 through the harder connection portion 22, which ensures the reliability of the connection, thereby preventing the ear tip 2 from falling off due to deformation of the connection portion 22. At the same time, the ear tip 2 may improve the comfort of wearing the earphone through the softer earbud portion 21. Furthermore, with reference to FIG. 3, FIG. 4, FIG. 5, and FIG. 6, the inner side wall of the connection portion 22 is provided with a locking groove 221. The snap fastener 121 extends into the locking groove 221 when the ear tip assembly structure 1 and the ear tip 2 are docked to achieve a snap connection. Thus, the connection portion 22 ensures the reliability of the snap connection between the ear tip 2 and the ear tip assembly structure 1 by providing the locking groove 221.

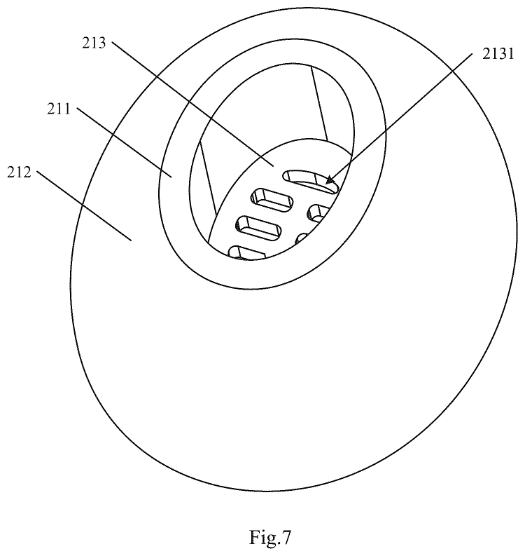

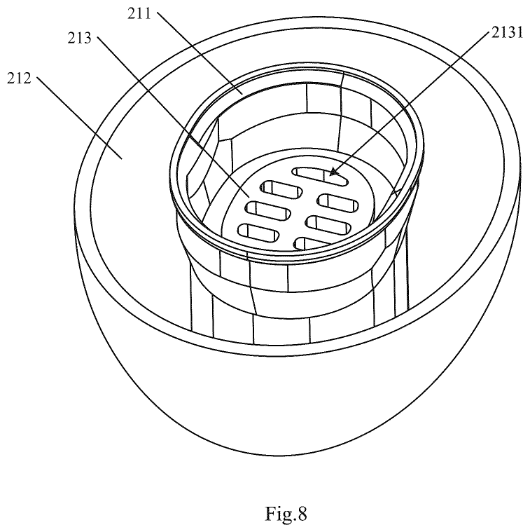

FIG. 7 is a schematic structural diagram of an earbud portion provided by an embodiment of the present disclosure. FIG. 8 is a schematic structural diagram of the earbud portion from another perspective provided by an embodiment of the present disclosure. With reference to FIG. 7 and FIG. 8, in one embodiment, the earbud portion 21 includes a conduit 211, a cap body 212, and a partition 213. Specifically, the conduit 211 is configured as a tubular structure to form a sound channel. The cap body 212 extends outward from the upper end of the conduit 211 to form a bowl-shaped structure. The partition 213 is disposed inside the conduit 211 to divide the sound channel into an upper section and a lower section. Further, the partition 213 is provided with a plurality of sound outlet holes 2131 communicating the upper section and the lower section. Furthermore, the connection portion 22 is located in the lower section, that is, at the lower end of the conduit 211. It is easy to understand that the lower end of the conduit 211 is configured as a profiled structure to match the connection portion 22.

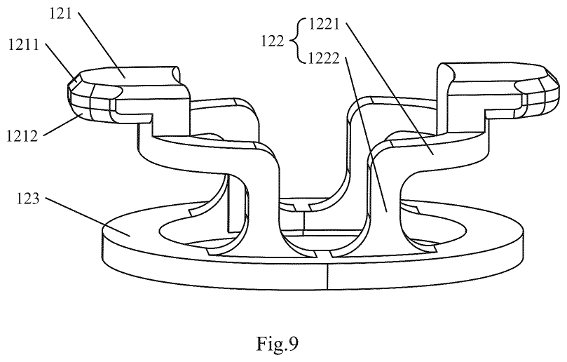

FIG. 9 is a schematic structural diagram of an elastic support provided by an embodiment of the present disclosure. As shown in FIG. 9, in one embodiment, the elastic support 12 further includes an elastic arm 122 and a base 123. Specifically, the elastic arm 122 is connected to the snap fastener 121 and is bent in a vertical direction, so that the elastic arm 122 may undergo elastic deformation smoothly when the snap fastener 121 is subjected to an external force, thereby enabling the snap fastener 121 to move or reset in the horizontal direction to withdraw from or extend into the locking groove 221. It should be noted that the elastic arm 122 of the elastic support 12 shown in FIG. 9 is bent downward in the vertical direction. As an optional embodiment, the elastic arm 122 of the elastic support 12 may also be bent upward in the vertical direction. Further, with reference to FIG. 3, FIG. 4, and FIG. 9, the base 123 is connected to the elastic arm 122 and abuts against the bottom of the sound guide tube 11, which helps to position the elastic arm 122 and the snap fastener 121 to ensure that the snap fastener 121 may stably withdraw from or extend into the locking groove 221. Furthermore, as shown in FIG. 9, the elastic arm 122 includes a bearing portion 1221 and a support portion 1222. The bearing portion 1221 extends horizontally from the snap fastener 121. The support portion 1222 extends vertically from the bearing portion 1221 and is connected to the base 123. Thus, the elastic arm 122 may effectively utilize its own elastic deformation to ensure that the snap fastener 121 may stably withdraw from or extend into the locking groove 221. Optionally, there are two snap fasteners 121, and there are two locking grooves 221 corresponding one-to-one with the snap fasteners 121. There are four elastic arms 122 so that each snap fastener 121 may be connected to one elastic arm 122 on each side. The base 123 is configured as a ring structure to adapt to the sound guide tube 11 and simultaneously connect the four support portions 1222. Meanwhile, the bearing portion 1221 is adapted to the sound guide tube 11 and formed into an arc shape.

With reference to FIG. 3, FIG. 4, and FIG. 6, in one embodiment, the inner side wall of the bottom of the connection portion 22 is provided with a guide surface 222. The guide surface 222 inclines outward from top to bottom. Further, with reference to FIG. 3, FIG. 4, and FIG. 9, the top of the snap fastener 121 is provided with a mating surface 1211. The mating surface 1211 inclines outward from top to bottom. Thus, when the ear tip 2 moves toward the ear tip assembly structure 1 for assembly, the mating surface 1211 contacts and slides against the guide surface 222, causing the snap fastener 121 to move inward under the action of the connection portion 22 and driving the elastic arm 122 to undergo elastic deformation, so that after the elastic arm 122 resets, the snap fastener 121 may extend into the locking groove 221 to complete the snap connection.

As shown in FIG. 9, in one embodiment, the bottom of the snap fastener 121 is provided with an arc surface 1212. Thus, when the ear tip 2 needs to be pulled out from the ear tip assembly structure 1, the snap fastener 121 may conveniently move inward by utilizing the arc surface 1212 to contact and receive force, thereby achieving disengagement from the locking groove 221.

With reference to FIG. 4, FIG. 5, and FIG. 6, in one embodiment, the lower wall 2211 of the locking groove 221 is arranged horizontally. Further, the upper wall 2212 of the locking groove 221 inclines outward from top to bottom. Thus, the locking groove 221 may ensure that the snap fastener 121 is difficult to disengage easily through the lower wall 2211, and may also form an avoidance by adapting to the snap fastener 121 through the upper wall 2212 to improve the service life of the ear tip assembly structure 1.

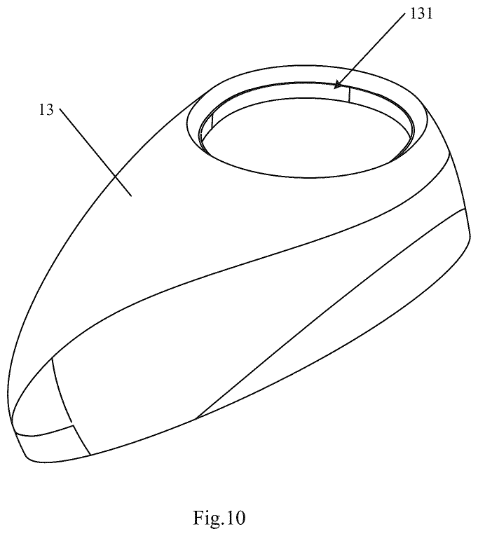

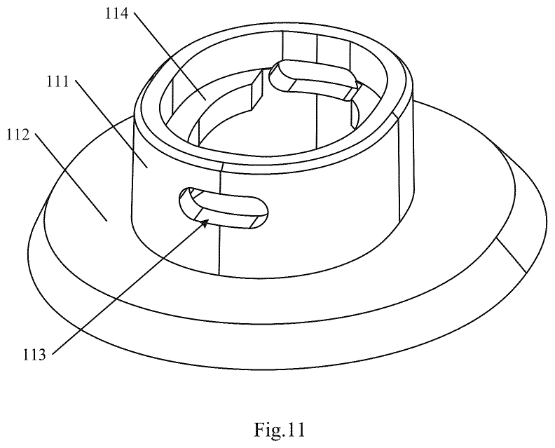

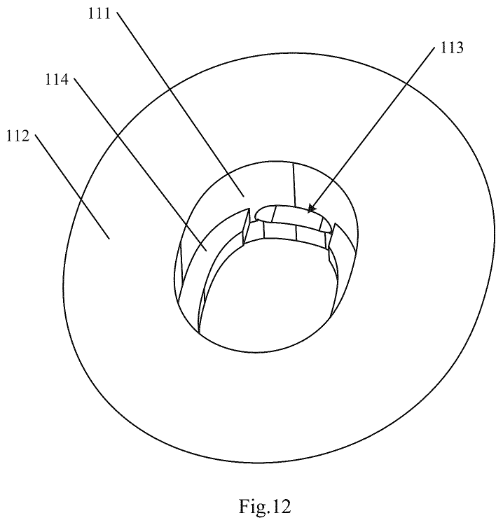

FIG. 10 is a schematic structural diagram of a housing provided by an embodiment of the present disclosure. As shown in FIG. 10, in one embodiment, the housing 13 is provided with an opening 131. It should be noted that FIG. 10 only shows part of the structure of the housing 13. The complete housing 13 may form a closed accommodating cavity capable of accommodating electronic components. FIG. 11 is a schematic structural diagram of a sound guide tube provided by an embodiment of the present disclosure. FIG. 12 is a schematic structural diagram of the sound guide tube from another perspective provided by an embodiment of the present disclosure. With reference to FIG. 11 and FIG. 12, in one embodiment, the sound guide tube 11 includes a main body portion 111 and an outward expansion portion 112. The main body portion 111 is configured as a tubular structure. The outward expansion portion 112 extends outward from the lower end of the main body portion 111 to form a disc-shaped structure. Further, as shown in FIG. 4, the outward expansion portion 112 is located inside the housing 13 and abuts against the inner wall of the housing 13 to form a closed structure at the connection. The main body portion 111 extends out of the housing 13 through the opening 131 to dock with the ear tip 2. Furthermore, as shown in FIG. 4, the bottom of the ear tip 2 is disposed between the housing 13 and the sound guide tube 11 and abuts against both the housing 13 and the outward expansion portion 112, which may further prevent the ear tip 2 from falling off.

With reference to FIG. 11 and FIG. 12, in one embodiment, the side wall of the sound guide tube 11 is provided with a snap hole 113, that is, the side wall of the main body portion 111 is provided with a snap hole 113. As shown in FIG. 4, the snap fastener 121 extends out of the sound guide tube 11 through the snap hole 113. It should be noted that corresponding to the two snap fasteners 121, there are two snap holes 113, and their positions, shapes, and sizes match the snap fasteners 121.

With reference to FIG. 11 and FIG. 12, in one embodiment, the inner side wall of the main body portion 111 protrudes inward to form a first protrusion portion 114. It should be noted that there are two first protrusion portions 114 distributed on both sides of the snap hole 113. The shape of the first protrusion portion 114 matches the elastic arm 122, that is, the first protrusion portion 114 matches the elastic support 12. Thus, the sound guide tube 11 may restrict the movement direction of the snap fastener 121 through the first protrusion portion 114 to ensure that the snap fastener 121 may stably extend into or withdraw from the locking groove 221. At the same time, the first protrusion portion 114 may also restrict the part where the elastic arm 122 elastically deforms to further ensure that the snap fastener 121 may stably extend into or withdraw from the locking groove 221.

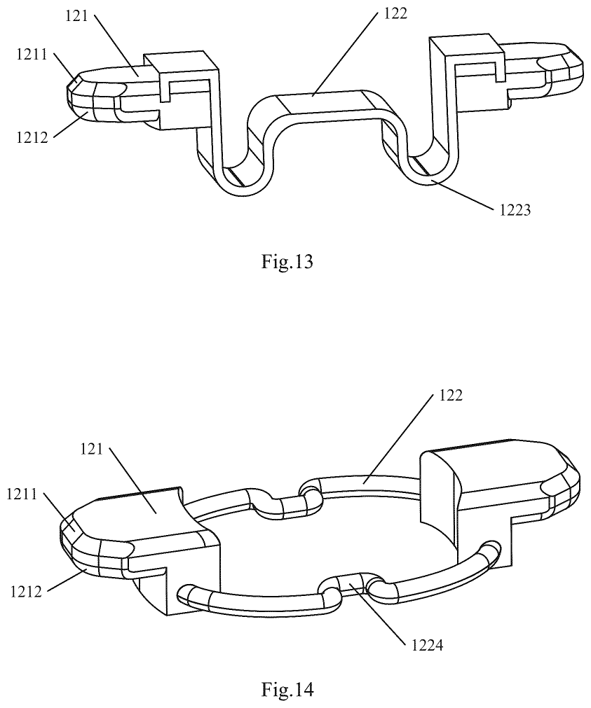

FIG. 13 is a schematic structural diagram of another elastic support provided by an embodiment of the present disclosure. As shown in FIG. 13, in one embodiment, the elastic support 12 further includes an elastic arm 122. Specifically, the elastic arm 122 is connected to the snap fastener 121 and is bent in a vertical direction, so that the elastic arm 122 may undergo elastic deformation smoothly when the snap fastener 121 is subjected to an external force, thereby enabling the snap fastener 121 to move or reset in the horizontal direction to withdraw from or extend into the locking groove 221. It should be noted that the elastic arm 122 of the elastic support 12 shown in FIG. 13 is bent downward in the vertical direction. As an optional embodiment, the elastic arm 122 of the elastic support 12 may also be bent upward in the vertical direction. Further, as shown in FIG. 13, the elastic arm 122 is formed by bending a sheet elastic body in the vertical direction to form a U-shaped first bent portion 1223. Thus, the elastic arm 122 may effectively utilize its own elastic deformation to ensure that the snap fastener 121 may stably withdraw from or extend into the locking groove 221. Optionally, there are two snap fasteners 121, and there are two locking grooves 221 corresponding one-to-one with the snap fasteners 121. The two snap fasteners 121 are connected by one elastic arm 122. Meanwhile, the elastic arm 122 is provided with two first bent portions 1223 corresponding one-to-one with the snap fasteners 121. It should be noted that the elastic support 12 shown in FIG. 13 may extend the snap fastener 121 by providing a snap hole 113 on the sound guide tube 11, and may also be guided and limited by providing a first protrusion portion 114 in the sound guide tube 11.

As shown in FIG. 13, in one embodiment, the top of the snap fastener 121 is provided with a mating surface 1211. The mating surface 1211 inclines outward from top to bottom to match the guide surface 222 on the connection portion 22. Thus, when the ear tip 2 moves toward the ear tip assembly structure 1 for assembly, the mating surface 1211 contacts and slides against the guide surface 222, causing the snap fastener 121 to move inward under the action of the connection portion 22 and driving the elastic arm 122 to undergo elastic deformation, so that after the elastic arm 122 resets, the snap fastener 121 may extend into the locking groove 221 to complete the snap connection.

As shown in FIG. 13, in one embodiment, the bottom of the snap fastener 121 is provided with an arc surface 1212. Thus, when the ear tip 2 needs to be pulled out from the ear tip assembly structure 1, the snap fastener 121 may conveniently move inward by utilizing the arc surface 1212 to contact and receive force, thereby achieving disengagement from the locking groove 221.

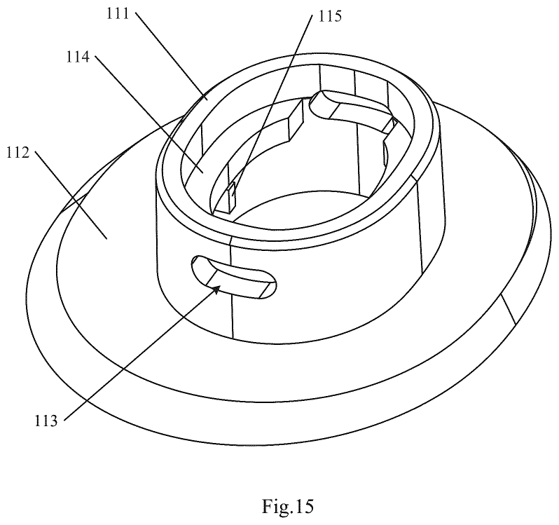

FIG. 14 is a schematic structural diagram of yet another elastic support provided by an embodiment of the present disclosure. As shown in FIG. 14, in one embodiment, the elastic support 12 further includes an elastic arm 122. Specifically, the elastic arm 122 is connected to the snap fastener 121 and is bent in a horizontal direction, so that the elastic arm 122 may undergo elastic deformation smoothly when the snap fastener 121 is subjected to an external force, thereby enabling the snap fastener 121 to move or reset in the horizontal direction to withdraw from or extend into the locking groove 221. It should be noted that the elastic arm 122 of the elastic support 12 shown in FIG. 14 is bent inward in the horizontal direction. As an optional embodiment, the elastic arm 122 of the elastic support 12 may also be bent outward in the horizontal direction. Further, as shown in FIG. 14, the elastic arm 122 is formed by bending a rod-shaped elastic body in the horizontal direction to form a U-shaped second bent portion 1224. Thus, the elastic arm 122 may effectively utilize its own elastic deformation to ensure that the snap fastener 121 may stably withdraw from or extend into the locking groove 221. Optionally, there are two snap fasteners 121, and there are two locking grooves 221 corresponding one-to-one with the snap fasteners 121. The two snap fasteners 121 are connected by two elastic arms 122. Meanwhile, each elastic arm 122 is provided with one second bent portion 1224.

As shown in FIG. 14, in one embodiment, the top of the snap fastener 121 is provided with a mating surface 1211. The mating surface 1211 inclines outward from top to bottom to match the guide surface 222 on the connection portion 22. Thus, when the ear tip 2 moves toward the ear tip assembly structure 1 for assembly, the mating surface 1211 contacts and slides against the guide surface 222, causing the snap fastener 121 to move inward under the action of the connection portion 22 and driving the elastic arm 122 to undergo elastic deformation, so that after the elastic arm 122 resets, the snap fastener 121 may extend into the locking groove 221 to complete the snap connection.

As shown in FIG. 14, in one embodiment, the bottom of the snap fastener 121 is provided with an arc surface 1212. Thus, when the ear tip 2 needs to be pulled out from the ear tip assembly structure 1, the snap fastener 121 may conveniently move inward by utilizing the arc surface 1212 to contact and receive force, thereby achieving disengagement from the locking groove 221.

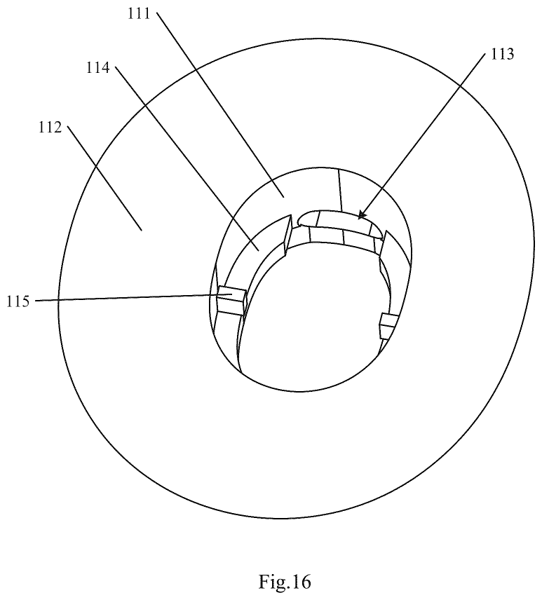

FIG. 15 is a schematic structural diagram of another sound guide tube provided by an embodiment of the present disclosure. FIG. 16 is a schematic structural diagram of the another sound guide tube from another perspective provided by an embodiment of the present disclosure. With reference to FIG. 15 and FIG. 16, in one embodiment, the sound guide tube 11 includes a main body portion 111 and an outward expansion portion 112. The main body portion 111 is configured as a tubular structure. The outward expansion portion 112 extends outward from the lower end of the main body portion 111 to form a disc-shaped structure. It should be noted that the outward expansion portion 112 is located inside the housing 13 and abuts against the inner wall of the housing 13 to form a closed structure at the connection. The main body portion 111 extends out of the housing 13 through the opening 131 to dock with the ear tip 2. It should be further noted that the bottom of the ear tip 2 is disposed between the housing 13 and the sound guide tube 11 and abuts against both the housing 13 and the outward expansion portion 112, which may further prevent the ear tip 2 from falling off.

With reference to FIG. 15 and FIG. 16, in one embodiment, the side wall of the sound guide tube 11 is provided with a snap hole 113. It should be noted that the snap fastener 121 extends out of the sound guide tube 11 through the snap hole 113. It should be further noted that corresponding to the two snap fasteners 121, there are two snap holes 113, and their positions, shapes, and sizes match the snap fasteners 121.

With reference to FIG. 15 and FIG. 16, in one embodiment, the inner side wall of the main body portion 111 protrudes inward to form a first protrusion portion 114 and a second protrusion portion 115. It should be noted that there are two first protrusion portions 114 and two second protrusion portions 115, distributed on both sides of the snap hole 113. With reference to FIG. 14, FIG. 15, and FIG. 16, the shape and position of the first protrusion portion 114 match the elastic arm 122, and the shape and position of the second protrusion portion 115 match the second bent portion 1224. That is to say, the second protrusion portion 115 is located at the bent position of the elastic arm 122 and matches the elastic arm 122. Thus, the sound guide tube 11 may restrict the movement direction of the snap fastener 121 through the first protrusion portion 114 to ensure that the snap fastener 121 may stably extend into or withdraw from the locking groove 221. At the same time, the second protrusion portion 115 may restrict the second bent portion 1224 to further ensure that the snap fastener 121 may stably extend into or withdraw from the locking groove 221.

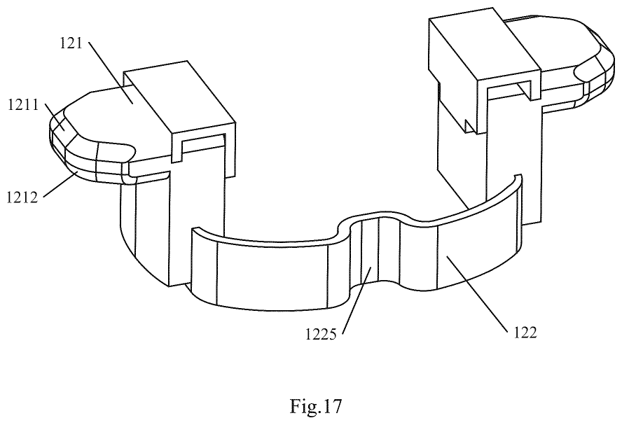

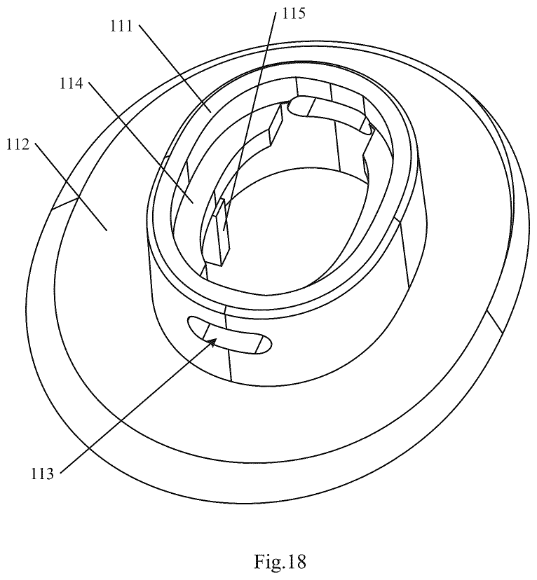

FIG. 17 is a schematic structural diagram of still another elastic support provided by an embodiment of the present disclosure. As shown in FIG. 17, in one embodiment, the elastic support 12 further includes an elastic arm 122. Specifically, the elastic arm 122 is connected to the snap fastener 121 and is bent in a horizontal direction, so that the elastic arm 122 may undergo elastic deformation smoothly when the snap fastener 121 is subjected to an external force, thereby enabling the snap fastener 121 to move or reset in the horizontal direction to withdraw from or extend into the locking groove 221. It should be noted that the elastic arm 122 of the elastic support 12 shown in FIG. 17 is bent inward in the horizontal direction. As an optional embodiment, the elastic arm 122 of the elastic support 12 may also be bent outward in the horizontal direction. Further, as shown in FIG. 17, the elastic arm 122 is formed by bending a sheet elastic body in the horizontal direction to form a U-shaped third bent portion 1225. Thus, the elastic arm 122 may effectively utilize its own elastic deformation to ensure that the snap fastener 121 may stably withdraw from or extend into the locking groove 221. Optionally, there are two snap fasteners 121, and there are two locking grooves 221 corresponding one-to-one with the snap fasteners 121. The two snap fasteners 121 are connected by one elastic arm 122. Meanwhile, the elastic arm 122 is provided with one third bent portion 1225.

As shown in FIG. 17, in one embodiment, the top of the snap fastener 121 is provided with a mating surface 1211. The mating surface 1211 inclines outward from top to bottom to match the guide surface 222 on the connection portion 22. Thus, when the ear tip 2 moves toward the ear tip assembly structure 1 for assembly, the mating surface 1211 contacts and slides against the guide surface 222, causing the snap fastener 121 to move inward under the action of the connection portion 22 and driving the elastic arm 122 to undergo elastic deformation, so that after the elastic arm 122 resets, the snap fastener 121 may extend into the locking groove 221 to complete the snap connection.

As shown in FIG. 17, in one embodiment, the bottom of the snap fastener 121 is provided with an arc surface 1212. Thus, when the ear tip 2 needs to be pulled out from the ear tip assembly structure 1, the snap fastener 121 may conveniently move inward by utilizing the arc surface 1212 to contact and receive force, thereby achieving disengagement from the locking groove 221.

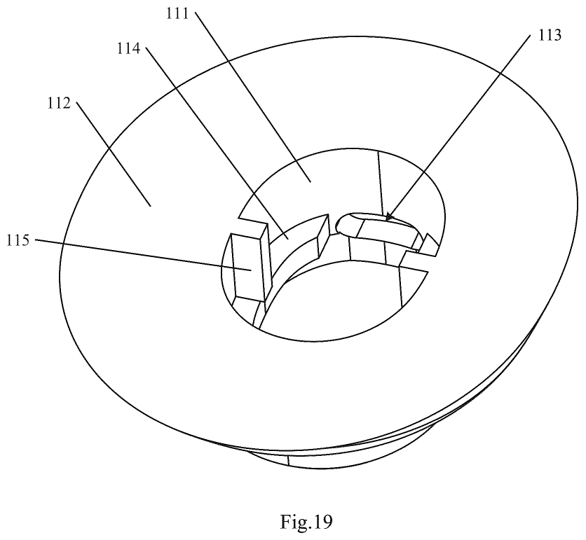

FIG. 18 is a schematic structural diagram of yet another sound guide tube provided by an embodiment of the present disclosure. FIG. 19 is a schematic structural diagram of the yet another sound guide tube from another perspective provided by an embodiment of the present disclosure. With reference to FIG. 18 and FIG. 19, in one embodiment, the sound guide tube 11 includes a main body portion 111 and an outward expansion portion 112. The main body portion 111 is configured as a tubular structure. The outward expansion portion 112 extends outward from the lower end of the main body portion 111 to form a disc-shaped structure. It should be noted that the outward expansion portion 112 is located inside the housing 13 and abuts against the inner wall of the housing 13 to form a closed structure at the connection. The main body portion 111 extends out of the housing 13 through the opening 131 to dock with the ear tip 2. It should be further noted that the bottom of the ear tip 2 is disposed between the housing 13 and the sound guide tube 11 and abuts against both the housing 13 and the outward expansion portion 112, which may further prevent the ear tip 2 from falling off.

With reference to FIG. 18 and FIG. 19, in one embodiment, the side wall of the sound guide tube 11 is provided with a snap hole 113. It should be noted that the snap fastener 121 extends out of the sound guide tube 11 through the snap hole 113. It should be further noted that corresponding to the two snap fasteners 121, there are two snap holes 113, and their positions, shapes, and sizes match the snap fasteners 121.

With reference to FIG. 18 and FIG. 19, in one embodiment, the inner side wall of the main body portion 111 protrudes inward to form a first protrusion portion 114 and a second protrusion portion 115. It should be noted that there are two first protrusion portions 114 distributed on both sides of the snap hole 113. There is at least one second protrusion portion 115 located below the first protrusion portion 114. With reference to FIG. 17, FIG. 18, and FIG. 19, the shape and position of the first protrusion portion 114 match the elastic arm 122, and the shape and position of the second protrusion portion 115 match the third bent portion 1225. That is to say, the second protrusion portion 115 is located at the bent position of the elastic arm 122 and matches the elastic arm 122. Thus, the sound guide tube 11 may restrict the movement direction of the snap fastener 121 through the first protrusion portion 114 to ensure that the snap fastener 121 may stably extend into or withdraw from the locking groove 221. At the same time, the second protrusion portion 115 may restrict the third bent portion 1225 to further ensure that the snap fastener 121 may stably extend into or withdraw from the locking groove 221.

It should be noted that the ear tip assembly structure 1 may select any one of the aforementioned elastic supports 12 and the corresponding sound guide tube 11 according to actual needs.

It should be noted that before the ear tip 2 provided by the embodiment of the present disclosure is assembled on the ear tip assembly structure 1, the elastic arm 122 is in a natural state and the snap fastener 121 is in an initial position; when the ear tip 2 is pressed further downward, the connection portion 22 of the ear tip 2 presses the snap fastener 121 to cause the snap fastener 121 to retract inward; when the ear tip 2 is assembled in place, the snap fastener 121 returns to the initial position under the action of the elastic arm 122, thereby cooperating with the locking groove 221 to lock the ear tip 2 to prevent the ear tip 2 from falling off.

It should be noted that after the ear tip 2 provided by the embodiment of the present disclosure is assembled on the ear tip assembly structure 1, the elastic arm 122 is in a natural state and the snap fastener 121 is in an initial position; when the ear tip 2 is pulled out with force, the force value reaching the design requirement force value may cause the connection portion 22 to compress the snap fastener 121, causing the snap fastener 121 to retract inward, thereby achieving the removal of the ear tip 2. For example, the design requirement force value is set to 8N.

An embodiment of the present disclosure provides an earphone. The earphone includes an ear tip assembly structure and an ear tip. The ear tip assembly structure includes a housing, a sound guide tube, and an elastic support. The sound guide tube includes a main body portion and an outward expansion portion formed by extending the lower end of the main body portion outward. The outward expansion portion is located inside the housing and abuts against the inner wall of the housing. The main body portion extends out of the housing. The elastic support is disposed inside the sound guide tube and includes a snap fastener. The snap fastener extends out of the sound guide tube. The ear tip is provided with a locking groove to engage with the snap fastener. The bottom of the ear tip is disposed between the housing and the sound guide tube. The ear tip abuts against both the housing and the outward expansion portion. Thus, the earphone allows the ear tip to be simply assembled and not easily dislodged by engaging the ear tip with the housing and the sound guide tube through the snap connection.

The above are only preferred embodiments of the present application and are not intended to limit the present application. For those skilled in the art, the present application may have various modifications and changes. Any modifications, equivalent replacements, improvements, etc., made within the spirit and principle of the present application shall be included within the protection scope of the present application.

I/We claim:

1. An earphone, comprising:
an ear tip assembly structure, the ear tip assembly structure comprising a housing, a sound guide tube, and an elastic support, the sound guide tube comprising a main body portion and an outward expansion portion, the outward expansion portion extending outward from a lower end of the main body portion, the outward expansion portion being located inside the housing and abutting against an inner wall of the housing, the main body portion extending out of the housing, the elastic support being disposed inside the sound guide tube and comprising a snap fastener, the snap fastener extending out of the sound guide tube; and
an ear tip, the ear tip being provided with a locking groove to engage with the snap fastener, a bottom of the ear tip being disposed between the housing and the sound guide tube, the ear tip abutting against both the housing and the outward expansion portion.

2. The earphone according to claim 1, wherein an inner side wall of the main body portion protrudes inward to form a first protrusion portion, the first protrusion portion matching with the elastic support.

3. The earphone according to claim 1, wherein the elastic support further comprises:
an elastic arm, the elastic arm being connected to the snap fastener and being bent in a horizontal direction.

4. The earphone according to claim 3, wherein an inner side wall of the main body portion protrudes inward to form a second protrusion portion, the second protrusion portion being located at a bent position of the elastic arm and matching with the elastic arm.

5. The earphone according to claim 1, wherein the elastic support further comprises:
an elastic arm, the elastic arm being connected to the snap fastener and being bent in a vertical direction.

6. The earphone according to claim 5, wherein the elastic support further comprises:
a base, the base being connected to the elastic arm and abutting against the bottom of the sound guide tube.

7. The earphone according to claim 6, wherein the elastic arm comprises:
a bearing portion, the bearing portion extending horizontally from the snap fastener; and
a support portion, the support portion extending vertically from the bearing portion and being connected to the base.

8. The earphone according to claim 7, wherein two locking grooves are corresponding one-to-one with two snap fasteners, and each snap fastener is connected to one elastic arm on each of its two sides.

9. The earphone according to claim 8, wherein the base is configured as a ring shape, and support portions of four elastic arms are all connected to the base.

10. The earphone according to claim 6, wherein the elastic arm is bent in the vertical direction to form a first bent portion, and the first bent portion is configured as a U-shaped structure.

11. The earphone according to claim 3, wherein the elastic arm is configured as a rod-shaped structure and is bent in the horizontal direction to form a second bent portion, and the second bent portion is configured as a U-shaped structure.

12. The earphone according to claim 3, wherein the elastic arm is configured as a sheet-shaped structure and is bent in the horizontal direction to form a third bent portion, and the third bent portion is configured as a U-shaped structure.

13. The earphone according to claim 1, wherein the ear tip is provided with a guide surface, the guide surface inclining outward from top to bottom;
a top of the snap fastener is provided with a mating surface, the mating surface inclining outward from top to bottom.

14. The earphone according to claim 1, wherein a bottom of the snap fastener is provided with an arc surface.

15. The earphone according to claim 1, wherein a lower wall of the locking groove is arranged horizontally;
an upper wall of the locking groove inclines outward from top to bottom.

16. The earphone according to claim 1, wherein a side wall of the sound guide tube is provided with a snap hole;
the snap fastener extends out of the sound guide tube through the snap hole.

17. The earphone according to claim 1, wherein the ear tip comprises an earbud portion and a connection portion, the earbud portion covers an outside of the connection portion and an inner side wall of the connection portion is provided with the locking groove.

18. The earphone according to claim 17, wherein the earbud portion comprises a conduit, a cap body, and a partition, the cap body is disposed at one end of the conduit, the partition is disposed inside the conduit, and the partition is provided with sound outlet holes.

19. The earphone according to claim 17, wherein hardness of the earbud portion is less than that of the connection portion.

20. The earphone according to claim 17, wherein the earbud portion is made of silicone material;
the connection portion is made of plastic material;
the earbud portion and the connection portion are integrally formed.
